(19) United States
(12) Patent Application Publication
(10) Pub. No.: US 2015/0261461 A1
(43) Pub. Date: Sep. 17, 2015

(54) HIGH PERFORMANCE PERSISTENT MEMORY

(71) Applicants: Sheng Li, San Jose, CA (US); Doe Hyun Yoon, San Jose, CA (US); Norman Paul Jouppi, Palo Alto, CA (US)

(72) Inventors: Sheng Li, San Jose, CA (US); Doe Hyun Yoon, San Jose, CA (US); Norman Paul Jouppi, Palo Alto, CA (US)

(21) Appl. No.: 14/423,913

(22) PCT Filed: Aug. 28, 2012
(86) PCT No.: PCT/US2012/052684

§ 371 Date: Feb. 25, 2015

(51) Int. Cl. G06F 3/06; G06F 12/08

(52) U.S. Cl. CPC G06F 3/0619; G06F 12/0891; G06F 3/0652; G06F 3/0656; G06F 3/0679; G06F 2212/1032; G06F 2212/202; G06F 2212/222; G06F 2212/251; G06F 2212/304; G06F 2212/69; G06F 2003/0691

(57) ABSTRACT

A method of performing data transactions in a high performance persistent memory comprising, with a processor, updating data by writing new data to non-volatile memory (NVM) and receiving a done signal from a transaction accelerator communicatively coupled to the NVM. An apparatus for high performance persistent memory, comprising a processor, a memory controller communicatively coupled to the processor, and non-volatile memory communicatively coupled to the memory controller and processor, the non-volatile memory comprising an ACID transaction accelerator, in which the processor updates data on the non-volatile memory (NVM) by writing new data to the NVM, and receives a done signal from the an ACID transaction accelerator when the data has been updated.

### BACKGROUND

Large data centers use large and relatively complex data structures. These data centers may manipulate large amounts of memory in order to process, send and receive information. One concern for modern data centers is business continuity in which a company or several companies rely on the system to run their operations. If the power provided to a data center system falls or the system crashes the company's operations may be partially impaired or operations may completely cease.

These power failures or system crashes may cause the system or an application to reboot. During a system reboot, the data center re-loads relatively complex data structures back onto the system. Data centers may load terabytes of information onto the system in order for the system to resume proper operation. Further, a system may address large amounts of data when initially loading a program. Loading such information onto the system could take several minutes or longer which may impact or stop business continuity all together.

### BRIEF DESCRIPTION OF THE DRAWINGS

The accompanying drawings illustrate various examples of the principles described herein and are a part of the specification. The examples do not limit the scope of the claims.

FIGS. 1A and 1B are block diagrams from a side and top view, respectively, of a memory system comprising a number of three-dimensional non-volatile memory (3D NVM) stacks according to one example of principles described herein.

FIG. 1C is a three-dimensional block diagram showing one of the three-dimensional non-volatile memory (3D NVM) stacks of FIGS. 1A and 1B according to one example of the principles described herein.

FIG. 2 is a flowchart showing a method of utilizing undo and redo logging with an atomic, consistent, isolated, durable (ACID) accelerator according to one example of principles described herein.

FIG. 3 is a flowchart showing a method for undo logging with the ACID accelerator according to one example of principles described herein.

FIG. 4 is a flowchart showing a method of redo logging with the ACID accelerator according to one example of principles described herein.

FIGS. 5A and 5B are accelerator designs for undo logging and redo logging, respectively, according to one example of principles described herein.

FIG. 6 is a flowchart showing a method of scheduling memory between a memory controller and an ACID accelerator and efficiently writing data to NVM according to one example of the principles described herein.

Throughout the drawings, identical reference numbers designate similar, but not necessarily identical, elements.

### DETAILED DESCRIPTION

The present specification describes a method of performing data transactions in high performance persistent memory comprising, with a processor, updating data by writing new data to non-volatile memory (NVM) and receiving a done signal from a transaction accelerator communicatively coupled to the NVM.

The present specification further describes an apparatus for high performance persistent memory, comprising a processor, a memory controller communicatively coupled to the processor, and non-volatile memory communicatively coupled to the memory controller and processor, the non-volatile memory comprising an ACID transaction accelerator, in which the processor updates data on the non-volatile memory (NVM) by writing new data to the NVM, and receives a done signal from the ACID transaction accelerator when the data has been updated.

The present specification also describes a computer program product for performing ACID transactions in a high performance persistent memory device. The computer program product may comprise a computer readable storage medium comprising computer usable program code embodied therewith. The computer usable program code may comprise computer usable program code to, when executed by a processor, update data by writing new data to non-volatile memory (NVM) and receive a done signal from a transaction accelerator communicatively coupled to the NVM.

As noted above, large data centers use large and relatively complex data structures. These data centers may manipulate a large amount of memory in order to process, send and receive information. One concern for modern data centers is business continuity in which a company or several companies rely on the system to run their operations. If the power provided to a data center system fails or the system crashes, the company's operations may be partially impaired or operations may completely cease. Consequently, these power failures or system crashes may cause the system or a program running on the system to reboot. During a system reboot, the data center re-loads relatively complex data structures back onto the system. Data centers may load terabytes of information onto the system in order for the system to resume proper operation. Further a system may address large amounts of data when initially loading a program. Loading such information onto the system could take several minutes or longer which may impact or stop business continuity all together.

In order to load these large and relatively complex data structures, a high performance persistent memory system may be used to process that large amount of data in a quick, inexpensive, and efficient manner. Accomplishing this, the large and complex data structures may be ready for use when a program starts or after the program or system reboots.

In one example of the present description, the 3D NVM achieves a much higher performance than existing implementations. This is accomplished by maintaining checkpointing locally in the NVM without the complex undo and redo log constraints. Thus, if a system using high performance persistent memory, as described herein, loses power, the program hangs, or the system crashes, the last transaction is used as a checkpoint to restore system data. In one example, the 3D NVM may provide hardware support for separating cache systems from durability to achieve inexpensive universal persistent memory without forfeiting performance and programming flexibility with minimal changes to the processor and operating system's architecture.

In various examples, a high performance persistent memory system described herein is used for data centers with relatively large in-memory data sets. Often large amounts of memory are loaded onto a computer system. This data may be used to, for example, load a large operating system comprising of a complex data structure onto a computer when the computer is initially powered on. Additionally, this data may include relatively complex data structures that provide functionality for a program. The present high-performance persistent memory system leverages a number of 3D NVMs with a logic stack to quickly access data after a crash without reading bytes serially from memory and building data structures in the memory.

As used in the present specification and in the appended claims, the term “high performance persistent memory” is meant to be understood broadly as fast access non-volatile memory (NVM) that can retain and store information even when the power to the device is no longer available. High performance persistent memory may therefore retain data if and when a program running on the system is disrupted or the system experiences a drop in power.

Additionally, as used in the present specification and in the appended claims the term “three-dimensional non-volatile memory (3D NVM)” refers broadly to any memory storage medium wherein data can be stored and retrieved. In one example, the 3D NVM may not require power to sustain the information stored thereon. Still further, in one example, a number of 3D NVMs may be stacked on top of each other allowing for vertical expansion of the high performance persistent memory.

Further, as used in the present specification and in the appended claims, the term “logic die” is meant to be understood broadly as a small block of semiconducting material on which functional integrated circuits are fabricated. In one example, the logic die provides architecture support for the high persistent memory.

Still further, as used in the present specification and in the appended claims, the term “logical operation” is meant to be understood as any operation involving the use of logical functions, such as “AND” or “OR”, that are applied to the input signals of a particular logic circuit. A logical operation may also be referred to as a “transaction.”

Even further, as used in the present specification and in the appended claims, the term “ACID transaction” is meant to be understood broadly as any set of transaction properties that provide that a transaction sent to the database is processed reliably. In one example, a set of properties are defined for each transaction such that they are atomic, consistent, isolated and durable (ACID).

For a transaction to be “atomic” each transaction is entirely committed. Therefore, if a transaction is “atomic” then, when one part of the transaction fails, the whole transaction will fail and the state of the non-volatile memory will remain unchanged.

Further, for a transaction to be “consistent” each transaction made will bring the database from one valid state into another valid state. Any data written to a database is assured to be valid for all predefined rules. These rules may include, but are not limited to cascades, triggers, or constraints. For example, if a transaction is requested and the system process determines the transaction will move data into an invalid state the transaction is not executed.

Additionally, for a transaction to be “isolated” this property ensures that if a number of transactions were to be executed instead of sequentially, the result will comprise the same system state as if the transactions were executed serially. Thus, any one transaction executed before, after, or concurrently with another transaction, each will result in the same state.

Further, for a transaction to be “durable,” once a transaction is committed, it will remain committed or stored permanently, even in the event of power loss or system crash. Thus, the transaction is non-volatile and persistent.

Examples of the present system and method are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program code. This computer program code may be provided to a processor of a general purpose computer, special purpose computer, or other programmable data processing apparatus to produce a machine, such that the code, which executes via a processor of the computer or other programmable data processing apparatus, to implement the functions/acts specified in the flowchart(s) and/or block diagram block or blocks.

In one example, this computer program code may be stored in a computer-readable storage medium that can direct a computer or other programmable data processing apparatus to function in a particular manner, such that the code stored in the computer-readable memory produces an article of manufacture including program code which implements the functions/act specified in the flowchart(s) and/or block diagram blocks or blocks.

The computer program code may also be loaded onto a computer or other programmable data processing apparatus to cause a series of operations to be performed on the computer or other programmable apparatus to produce a computer implemented process such that the computer code which executes on the computer or other programmable apparatus implements the functions/acts specified in the flowchart(s) and/or block diagram blocks or blocks.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

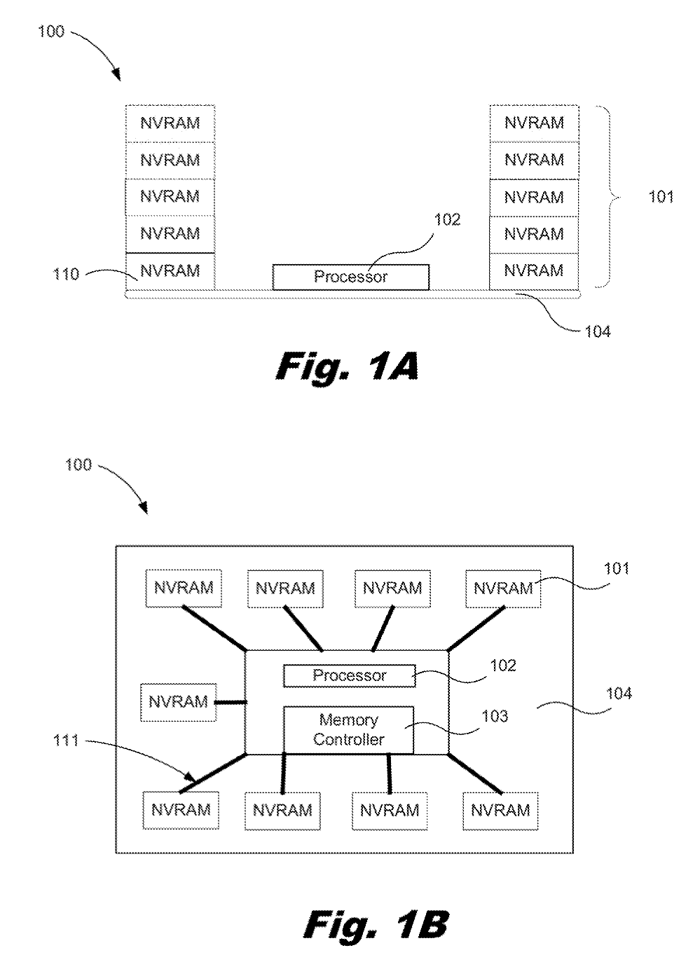

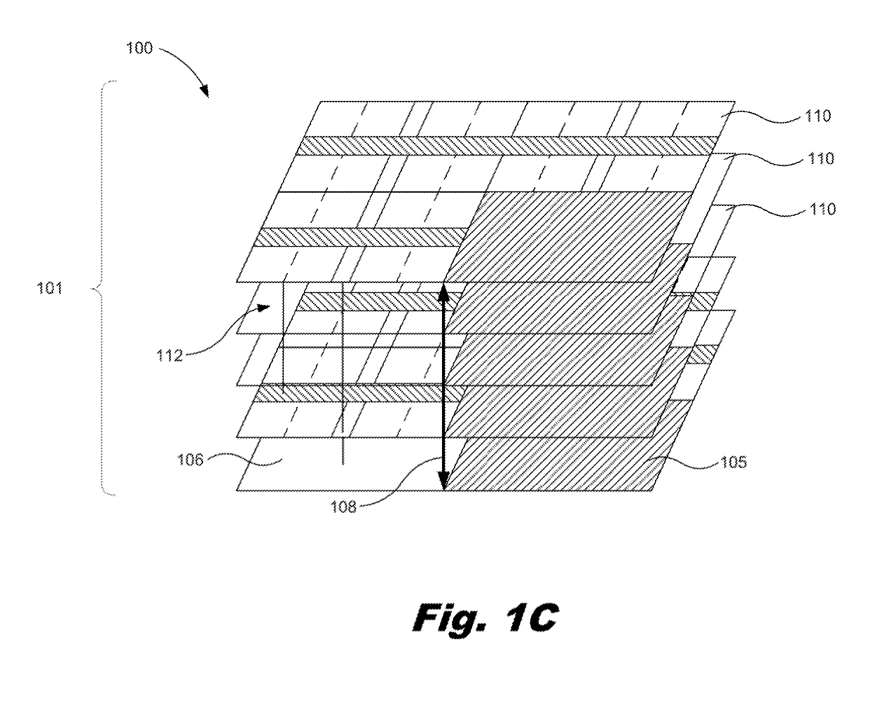

Referring now to the Figures, FIG. 1A shows a side view block diagram of a memory system (100) comprising a number of three-dimensional non-volatile memory (3D NVM) stacks (101) according to one example of principles described herein. As illustrated in the system (100), the 3D NVM stacks (101) may include a number of vertically placed slices of non-volatile memory (NVM) (110) comprising multiple NVM dies. Other examples of memory which may be used may include memory devices such as ROM, nvSRAM, FeRAM, MRAM, PRAM, CBRAM, SONOS, NRAM or other types of non-volatile memory. Therefore, although FIG. 1 shows a number of vertically stacked NVRAM (110) devices, the NVM devices may incorporate any type of non-volatile memory, NVRAM being an example.

Additionally, instead of the NVM being in the form of 3D NVM stacks (101), the NVM memory may instead be positioned in a two-dimensional configuration. Therefore, although FIGS. 1A, 1B, and 1C show the NVM stack (101) being three-dimensional, any memory configuration may be used in the present description without diverging from the principles described herein.

The vertically placed NVRAM devices (110) may be stacked on each other to produce a 3D stack (101) of NVMRAM devices (110). Each NVRAM device (110) within each of the 3D NVM stacks (101) may be communicatively coupled to a number of other NVRAM devices (110) in the 3D NVM stack (101) via a through-silicon via (TSV) (112, FIG. 1C) created in each of the NVRAM devices (110) during the manufacturing process. The TSVs (112, FIG. 1C) may act as a bus to allow all of the NVRAM devices (110) within the 3D NVM stacks (101) to behave as a single device.

In one example, the 3D NVMRAM stacks (101) may be used to build simple memory modules or to build scalable memory networks. Although FIG. 1 shows a number of vertically placed slices of NVRAM (110) stacked together forming a 3D NVRAM (101), the present specification contemplates that any number and type of NVM may be communicatively coupled together either horizontally or vertically. Stacking of the number of NVRAM devices (110) of may have a number of advantages. One advantage is that physical space within a computing system (100) is saved by taking advantage of the vertical space available above the memory board. The system (100) may therefore involve as few or as many NVRAM devices (110) in order for the system to operate.

The 3D NVRAM stacks (101) may receive data from a processor (102) and be directed to store the data thereon. Additionally, a memory controller (FIG. 1B, 103) may be used to manage the flow of data moving to and from each of the NVRAM devices (110) in the 3D NVM stacks (101).

FIG. 1B shows a top view block diagram of a memory system (100) comprising a number of three-dimensional non-volatile memory (3D NVM) stacks (101) according to one example of principles described herein. As discussed above, the NVRAM devices (110) may be controlled by a memory controller (103) that manages the data flow in and out of the 3D NVM stacks (101). Communication between the NVRAM devices (110) and the memory controller (103) may be accomplished by using routing interconnects (111) on a silicon interposer (104). In one example, the individual NVRAM devices (110) or three-dimensional non-volatile memory (3D NVM) stacks (101) may not be included on the same silicon interposer (104) and instead may be physically distant form the processor (102) and memory controller (103) while still being communicatively coupled to them via an interconnect (111).

In operation, the processor (102) may send executable code to the memory controller (103) so that the memory controller can manage the data flow to the individual NVRAM devices (110). In one example, the processor (102) may send updated data to the number of NVMRAM devices (110).

FIG. 1C is a three-dimensional block diagram showing one of the number of three-dimensional non-volatile memory (3D NVM) stacks (101) of FIGS. 1A and 1B according to one example of the principles described herein. Each vertically placed NVRAM device (110) may comprise portions of multiple NVM dies and may form single rank or multiple rank channels (108) between each NVRAM device (110). An ACID transaction accelerator (105) may be communicatively coupled to each of NVRAM devices (110) as well as on the logic die (106). In one example, the ACID transaction accelerator (105) may be physically coupled to the NVM such that it is placed on the logic die onto which the NVM devices (110) are also coupled. In another example, the ACID transaction accelerator (105) can physically exist apart form the logic die (106). Therefore, although FIG. 1C may show that the ACID transaction accelerator (105) is placed on a three-dimensional stack of NVM devices, other examples exist where the ACID transaction accelerator (105) is communicatively coupled to the NVM devices, but placed on its own logic die.

The transaction accelerator (105) is used to maintain atomic, consistent, isolated, and durable transactions as described above. Additionally, the accelerator (105) may ensure that minimal changes are made to the processor and operating system architecture of the system (100).

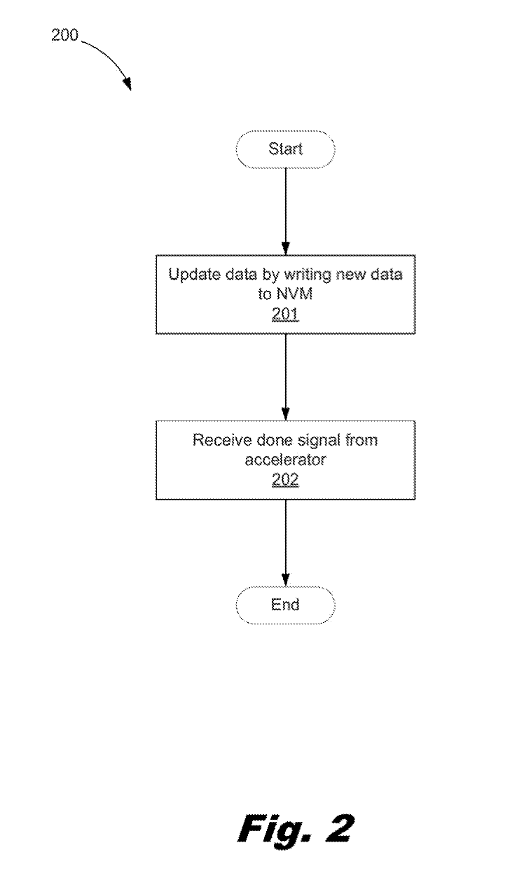

FIG. 2 is a flowchart showing a method of utilizing undo and redo logging using an ACID accelerator (105) according to one example of principles described herein. The method may begin by issuing an update (201) command, for example, by an operator, system, or device. Here the new data may be written to the NVM (201) according to the ACID properties mentioned above. During this process (200), the accelerator (105) may use a checkpointing technique to, with the current data in the NVM (110), store the current state of data being transferred. If, according to any of the ACID transaction properties, the update process or the transaction process fails and the new data is not written to the NVM, this checkpointing procedure will allow the system (100) to be able to restart at the point of failure.

As will be described below, the accelerator (105) may be given access to a number of buffers which contain new data received from the processor (102) and old data retained by the NVRAM device (110). Control logic may be used by the accelerator (105) to read the old data, log data to the NVRAM device (110), wait until the logging finishes, and write the buffered new data to the NVRAM device (110). During this process, however, the durability property is separate from the writing data process. In one example, by buffering the data in a new data buffer and an old data buffer on the accelerator (105), the memory operations may be optimized through bulk data processing.

In this case, updating the data to the NVRAM devices (110) by having the processor (102) read the old data, pushing a tuple comprising the address of the old data to an undo log, waiting until the tuple is written out to the undo log, and writing the new data to the 3D NVM stacks (101) need not happen. Here, it can be appreciated that the NVM will be accessed for both the log operation and the data updates.

Instead, the memory controller (103) as described in the present specification may simply write the new data to the 3D NVM stacks (101) and wait until all the data in the transaction is written out to the 3D NVM stacks (101). The ACID requirement that the transaction be durable is separated from the data access process and the system may provide a high performing, yet fast and cheap persistent memory system (100). Additionally, the logging operation is transparent to the processor (102) and the processor (102) will treat the transaction updates as regular memory updates.

Once all of the data has been written to the NVM a done signal will be received (202) from the accelerator (105). Thus, the ACID transaction is now stored in the appropriate 3D NVM stack (101). If a system (100) were to fail or lose power, the accelerator (105) can recognize the most recent version of persistent data.

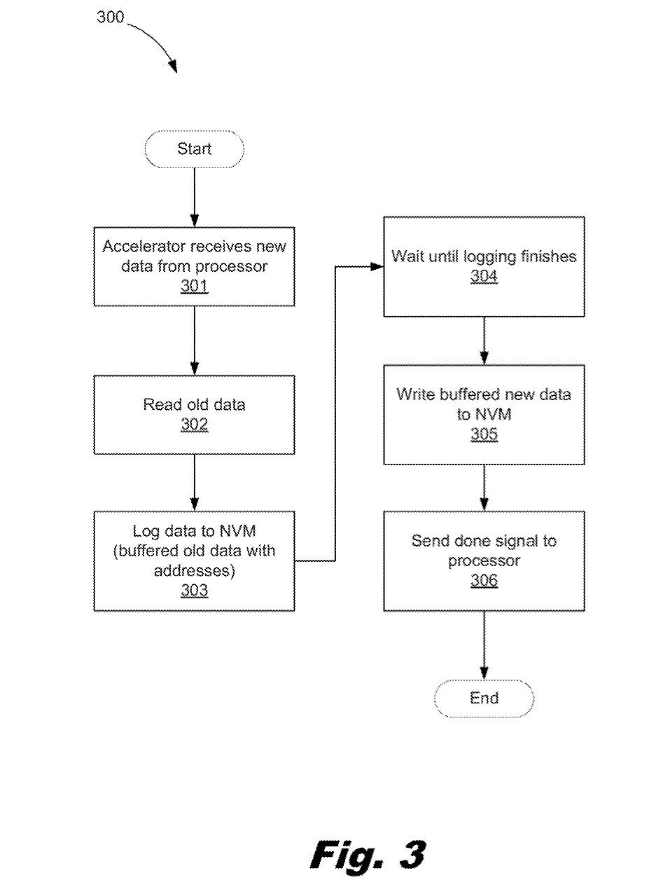

FIG. 3 is a flowchart showing a method (300) for undo logging with the ACID accelerator (105) according to one example of principles described herein. FIG. 3 shows how the system (100) of FIGS. 1A, 1B, and 1C completes ACID transactions as an undo logging transaction. The ACID transaction begins when the accelerator receives (301) new data from the processor (102). The old data is then read (302). The ACID accelerator then logs (303) bulk data the NVM. The bulk data may be defined as buffered old data with addresses defining where within the NVRAM devices (110) the data was stored. Using the bulk data that is buffered helps to optimize memory operations where write and wait time is optimized in the stacked NVM since there is no roundtrip delay between the NVM and memory controller. The system then waits (304) until logging is finished. Once logging has finished the buffered new data is written (305) the NVM.

The buffers within the accelerator (105) can be memory managed by the controller (103) or can be a cache like structure with hardware managed tag and metadata in addition to data blocks. Additionally, the accelerator (105) may perform multiple loggings for a transaction, or may handle multiple transactions at the same time.

As noted above, data may be reordered to improve the channel utilization, and the ACID accelerator (105), by buffering incoming data, may reconstruct the correct ordering. The processor (102) may direct the memory controller (103) to send metadata defining the order of the data along with the data and transaction ID. This metadata may be sent to the accelerator (105) via an express bus created between the last level cache and the controller (103). This bus may be dedicated to sending a write-reservation that includes the time stamp and transaction ID. Since the data to be sent over this bus includes meta-data, it may be relatively smaller than data of real memory accesses. Thus, the extra bus will incur minimal pressure on processor pin count. When the data write is complete a done signal is received from the accelerator (306) by the processor (102). Advantageously, any new data is written out to NVM after the old data is pushed to the undo log. Thus, serialization may be avoided in the architecture of the present example during undo logging.

Therefore, the present system (100) may allow memory writes of transactions to be issued from memory controller (103) out-of-order as if they were normal memory writes so as to maintain a high performance level. While the buffers within the ACID accelerator (105) can buffer and reorder the memory writes with the metadata to maintain the correct order with regards to transactions it is also possible for the buffers to be filled up with partially updated transactions. In other systems this may prevent a number of transactions from moving forward and the systems may be dead-locked. However, the present ACID accelerator (105) may place a threshold limit on how many partially committed transactions and their data can be queued up in the buffers. This threshold limit may be defined by the system (100) to fit any particular set of transactions or may be user defined.

Since the accelerator (105) is aware of how many transactions have been issued and how many cache lines have been updated based on the metadata stored in the accelerator's buffers and provided by the processor-side memory controller (103), the accelerator (105) may request the memory controller (103) to flush the dirty cache lines of the finished transactions (i.e. transactions not committed to the NVM (110)). In this case, the memory controller (103) may not be allowed to issue the memory required at will and based on its own scheduling policy. Through careful co-operation between the memory controller (103) and the ACID accelerator (105), the system (100) may be able to support persistent memory with minimal performance penalty and avoid any potential dead-locks. In one example, this persistency-aware memory scheduling may be implemented based on whether the instant durability is needed. In one example, the memory controller (103), processor (102), and operating system can also choose whether to allow memory writes to be issued out-of-order or just flush the data to the NVM (101) as soon as it may be allowed.

An example of the undo logging process according to the present application will now be described. Assume 5 transactions are sent to the ACID accelerator (105), namely; A, B, C, D, and E. Originally, these transactions are committed in alphabetical order. Further assume that these transactions produce the following data blocks, namely; A1, A2, A3, B4, B5, B6, C7, C8, D9, and E10. As described above, the transaction accelerator (105) may receive a number of write-reservations with time stamps and transaction IDs. In this way, the transaction accelerator (105) is notified of the fact that, for example, transaction A has 3 memory write blocks, A1, A2, and A3. Further assuming, the processor or memory controller (103) reorders the data writes so the NVM receives the following sequence: A1, E10, A2, B4, B5, C7, A3, C8, D9. B6. As described above the incoming data is first buffered (303). When A3 is received, the accelerator commits A1, A2, and A3 to NVM and a done signal is received from the accelerator (306). Further, B is not committed until B6 is received so the transactions B, C, D, and E are buffered. When B6 is received, the last transaction in the set, the ACID accelerator (105) has all the data for transactions B, C, D, and E. Consequently, serialization is avoided and all the transactions are then committed at the same time.

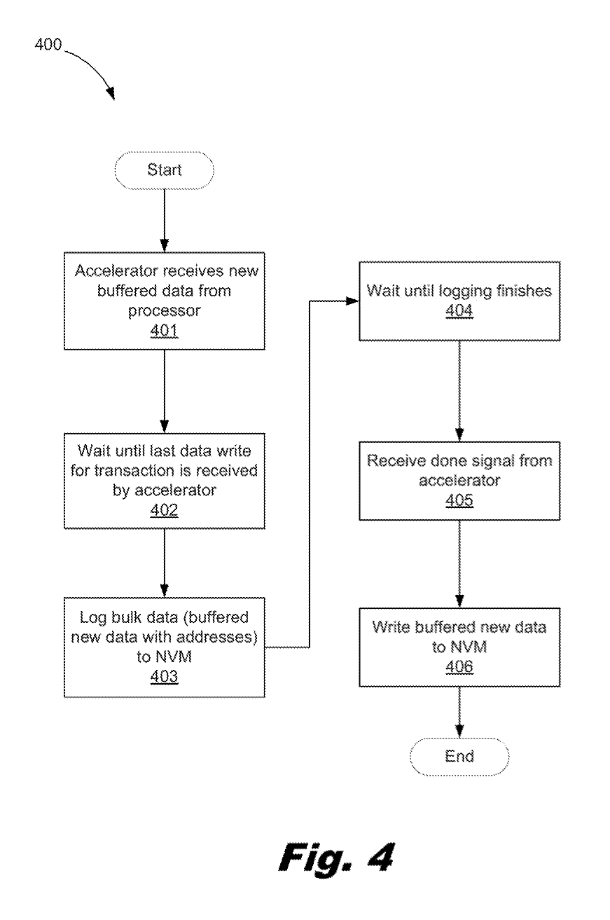

FIG. 4 is a flowchart showing a method for redo logging with the ACID accelerator (105) according to one example of principles described herein. FIG. 4 shows how the system (100) of FIGS. 1A, 1B, and IC completes ACID transactions as a redo logging transaction. The ACID transaction begins wherein the accelerator (105) receives (401) new buffered data from the processor (102). No further action is performed immediately until the last data write for the transaction is sent (402) to the accelerator (105). After all the new buffered data has been received by the accelerator (105), the bulk data is logged (403) to the NVM. Once logging (403) has been finished (404) a done signal is received (405) from the accelerator (105). When the done signal is received (405), the new buffered data is written (406) to the NVM.

Similar to above, the accelerator (105) may perform multiple loggings for a transaction, or may handle multiple transactions at the same time. Additionally, new data may be written (406) out to the NVM after the transaction finishes and the whole redo logging for the transaction is finished (404). Also, similar to undo logging, the ACID accelerator (105) can provide a relatively simpler interface by optimizing the memory operation with the bulk data processing by buffering the data, writing it, and waiting. This proves to be a much faster process within the stacked memory since there is no roundtrip delay between the 3D NVM stacks (101) and the memory controller (103). Still further, the processor can have the same interface, while the NVM stack chooses the optimal approach; namely undo logging (300) or redo logging (400) for ACID support.

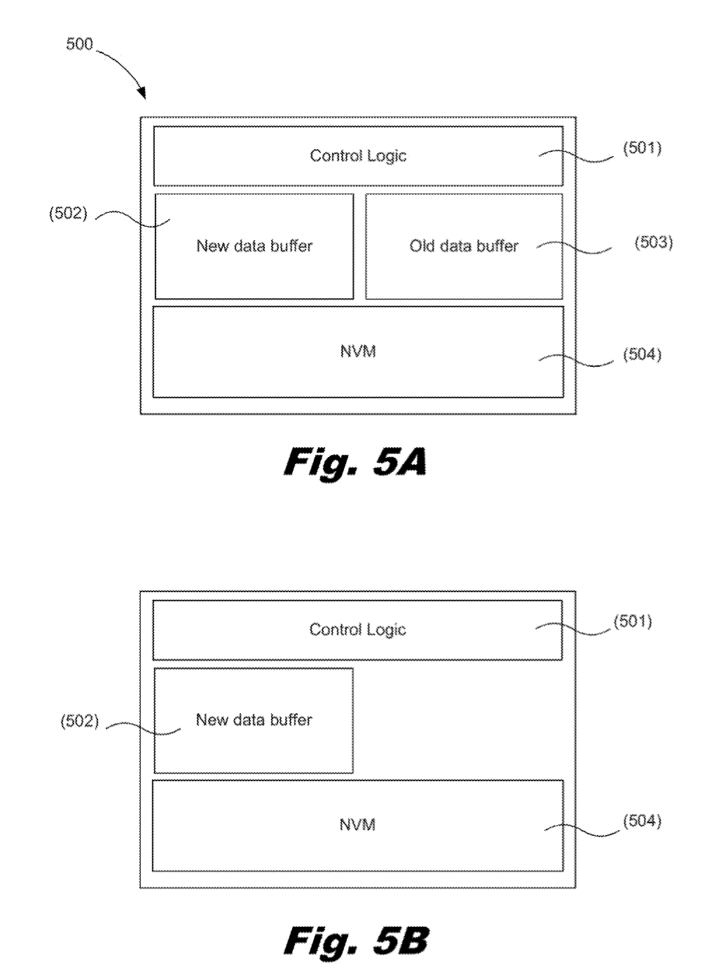

FIG. 5A is an illustration of an accelerator (500) design for undo logging according to one example of principles described herein. FIG. 5A shows a 3D NVM stack (101) within the system (100) of FIGS. 1A, 1B, and 1C with an accelerator (500) design for undo logging transaction. Undo logging provides for a logic controller (501) which may include hardware logic and a processor executing computer usable program code. Here, the controller (501) may produce the desired logic for the system. As noted above, both the new data and the old data is to be buffered when undo logging is desired and is written to NVM (504). FIG. 5A shows that the new data and old data may be stored, at least temporarily in a new (502) and old data buffer (503) respectively. These buffers (502, 503) may be reused once a consistent and/or persistent version of the data being updated has been created in the NVM (504). In one example, the operating system associated with the computing system and NVM (504) may help to allocate portions of the NVM (504). In some examples, different portions of the NVM (504) may be allocated to fit a variety of different transactions that may take place in connection with the NVM (504).

As discussed above, the system (100) may allow memory writes to be issued from memory controller (103) to the NVM (504) out-of-order as if they were normal memory writes. While the number of buffers (502, 503) within the ACID accelerator (105, 500) can buffer and reorder the memory writes with the metadata provided from the memory controller (103), it is possible for the number of buffers (502, 503) to be filled up with partially updated transactions. The ACID accelerator (105, 500), however, may place a threshold limit on how many partially committed transactions and their data can be queued up in the buffers. This threshold limit may be defined by the system (100) to fit any particular set of transactions or may be user defined.

Since the accelerator (105, 500) is aware of how many transactions have been issued and how many cache lines have been updated based on the metadata provided by the processor-side memory controller (103), the accelerator (105, 500) may request the memory controller (103) to flush the dirty cache lines of the finished transactions. In this case, the memory controller (103) may not be allowed to issue the memory required at will based on its own scheduling policy. Through co-operation between the memory controller (103) and the ACID accelerator (105, 500), the system (100) may be able to support persistent memory with minimal performance penalty. In one example, this persistency-aware memory scheduling may be implemented based on whether the instant durability is needed. In one example, the memory controller (103), processor (102), and operating system can also choose whether to allow memory writes to be issued out-of-order or just flush the data to the NVM (110) as soon as it may be allowed.

In one example, the ACID accelerator (105, 500), using the control logic (501) within the ACID accelerator (105, 500), may control the interfacing between the number of buffers (502, 503) and the NVM (110). In one example, as the number of buffers (502, 503) begin to fill up, the ACID accelerator (105, 500) will complete the log transactions in order to make sure that data is persistently logged when appropriate and as soon as possible. However, once any log transaction is completed, the ACID accelerator (105, 500) may write bulk data to the NVM (110) when appropriate. For example, if the target memory block within the NVM (110) may be busy when the ACID accelerator (105, 500) is attempting to write to that memory block, the ACID accelerator (105, 500) may first commit other transactions to the NVM (110) until that memory block becomes available. In this way, the ACID accelerator (105, 500) may take advantage of time that would have otherwise been spent waiting for busy memory blocks to complete other transactions.

FIG. 5B is an illustration of an accelerator (105) design example for undo logging according to one example of principles described herein. FIG. 5B shows a 3D NVM stack (101) within the system (100) of FIGS. 1A, 1B, and 1C with an accelerator (105) design for redo logging transaction. Redo logging provides for a logic controller (501) which may be hardware logic or a simple processor with computer usable program code embodied thereon. In either case the controller (501) is able to produce the desired logic for the system (100). As noted above, the new data (502) is to be buffered when redo logging is initiated and is written to the NVM (504).

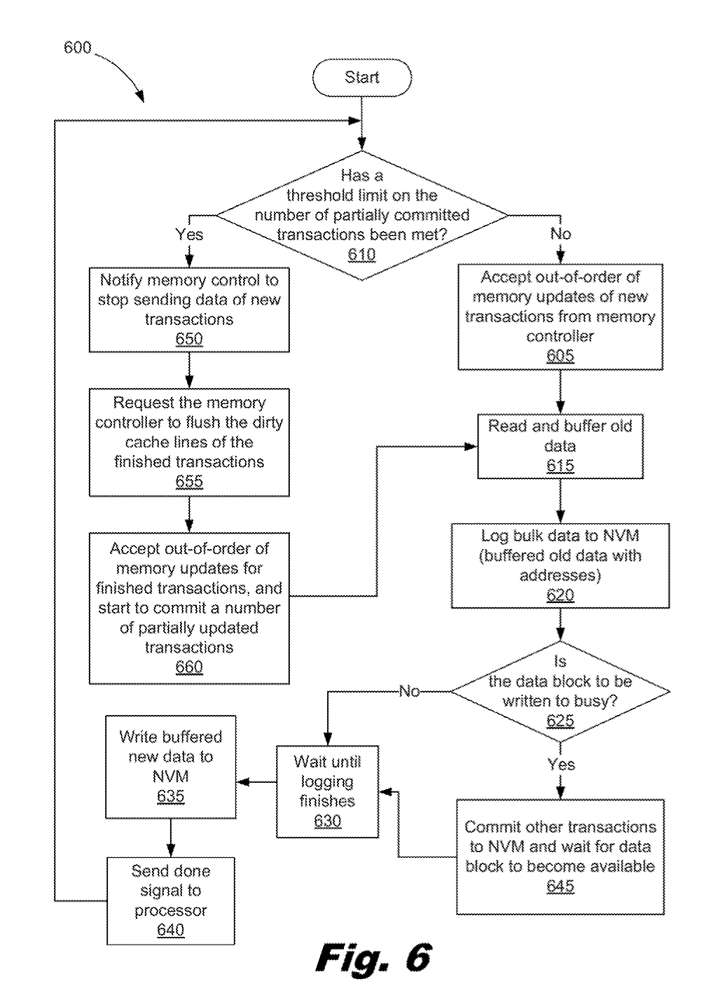

FIG. 6 is a flowchart showing a method (600) of scheduling memory between a memory controller (103) and an ACID accelerator (105, 500) as well as a method for efficiently writing data to the NVM (101) according to one example of the principles described herein. Although the two methods depicted here in FIG. 6 (i.e. the method of scheduling memory between a memory controller (103) and an ACID accelerator (105, 500) and the method for efficiently writing data to NVM (101)) are shown together as method 600, the present specification also contemplates that these two methods may be started and occur separately and independently of each other. Therefore, FIG. 6 is meant to be understood as being merely an example of the methods described herein.

While the processor and memory controller keep generating memory requests from both transactions and normal writes, the ACID accelerator (105, 500) may make a decision (610) as to whether a threshold limit on the number of partially committed transactions has been met. If the threshold has been met (Determination Yes, 610), the ACID accelerator (105, 500) may notify (650) the memory controller (103) to stop sending data of new transactions and request (655) that the memory controller (103) flush the dirty cache lines of the finished transactions. The ACID accelerator (105, 500) may then complete (660) a number of partially updated transactions by performing the logging and updating steps (605, 615, 620, 625, 630, 635, 645, 640) as mentioned below. Once this occurs, the ACID accelerator (105, 500) may then again determine (610) if the threshold limit on the number of partially committed transactions has been met. Therefore, in one example, the ACID accelerator (105, 500) may continually check after each completion of a partially updated transaction, whether the threshold limit has still been reached. In another example, the ACID accelerator (105, 500) may complete a predetermined number of partially updated transactions and then make the same query (610).

If the threshold has not been met (Determination No, 610), the ACID accelerator (105, 500) may complete the method of writing data to the NVM (110) by continuing to let the memory controller (103) issue a number of memory requests at will and accept (605) new data from the memory controller (103). As described above, the new data received (605) may be out-of-order.

The ACID accelerator (105, 500) may then read (615) the old data as described above. After reading (615) the old data, the ACID accelerator may then log (620) bulk data the NVM. A determination may then be made (625) as to if the data block that is to be written to is busy. If the data block is busy (Determination Yes, 625), then the ACID accelerator (105, 500) may commit (645) other transactions to the NVM and wait for the data block to become available. In this case, when the data block does become available, the process continues with the ACID accelerator (105, 500) waiting (630) until logging is finished, writing (635) the buffered new data to the NVM (110), and sending (640) a done signal to the processor (102) and memory controller (103).

If the data block is not busy (Determination No, 625), then the ACID accelerator (105, 500) waits (630) until logging is finished. The ACID accelerator (105, 500) then writes (635) the buffered new data to the NVM (110) and sends (640) a done signal to the processor (102) and memory controller (103). The whole process may then repeat throughout the execution of applications.

Although FIG. 6 above describes a method of scheduling memory between a memory controller (103) and an ACID accelerator (105, 500) and efficiently writing data to the NVM (110), in one example, the method may include only the method of scheduling memory between a memory controller (103) and the ACID accelerator (105). In another example, the method may include only the method of efficiently writing data to the NVM (110) as described above.

The present specification may also be described as a computer program product for performing ACID transactions in a high performance persistent memory device. The computer program product may comprise a computer readable storage medium comprising computer usable program code embodied therewith. The computer usable program code may comprise computer usable program code to, when executed by a processor, update data by writing new data to non-volatile memory (NVM) and computer usable program code to, when executed by a processor, receive a done signal from a transaction accelerator communicatively coupled to the NVM.

Any combination of computer readable medium(s) may be utilized in the present specification. A computer readable storage medium may be, for example, but not limited to, an electronic, magnetic, optical electromagnetic, infrared, or semiconductor system, apparatus, or device or any suitable combination of the foregoing. More specific examples (a non-exhaustive list) of the computer readable mediums would include the following: an electrical connection having a number of wires, a portable computer diskette, a hard disk, a random access memory (RAM), a read-only memory (ROM), an erasable programmable read-only memory (EPROP or Flash memory), an optical fiber, a portable compact disk read-only memory (CD-ROM), an optical storage device, a magnetic storage device, or any suitable combination of the foregoing. In the context of this document, a computer readable storage medium may be any tangible medium that can contain, or store a program for use by or in connection with any instruction execution system, apparatus, or device such as, for example, a processor.

Program code embodied on a computer readable medium may be transmitted using any appropriate medium, including but not limited to wireless, wireline, optical fiber cable, RF, etc., or any suitable combination of the foregoing.

Computer program code for carrying out operations of the present specification may be written in an object oriented programming language such as Java, Smalltalk, or C++, among others. Computer program code for carrying out operations of the present specification may also be written in declarative programming language such as Structured Query Language, However, the computer program code for carrying out operations of the present systems and methods may also be written in procedural programming languages, such as, for example, the “C” programming language or similar programming languages. The program code may execute entirely on the user's computer, partly on the user's computer, as a stand-alone computer readable medium package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, thought the internet using an internet service provider).

The flowchart and block diagrams in the figures illustrate the architecture, functionality, and operations of possible implementations of systems, methods, and computer program products. In this regard, each block in the flowchart or block diagrams may represent a module, segment, or portion of code, which comprises a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations and combination of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context dearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of performing data transactions in a high performance persistent memory comprising
with a processor:
updating data by writing new data to non-volatile memory (NVM); and
receiving a done signal from a transaction accelerator communicatively coupled to the NVM.

2. The method of claim 1, in which updating data comprises receiving new data from the processor at the transaction accelerator and temporarily buffering the new data in a new data buffer associated with the transaction accelerator.

3. The method of claim 2, in which the new data received comprises a number of partially committed transactions and in which, upon exceeding a threshold limit of the number of partially committed transactions in the buffer, the transaction accelerator instructs the processor to flush a number of dirty cache lines of a number of finished transactions.

4. The method of claim 3, in which, if a number of data blocks within the NVM to which the transaction accelerator is attempting to write a completed transaction to is busy, the transaction accelerator commits a number of other transactions to the NVM until the data block becomes available.

5. The method of claim 2, in which updating data comprises buffering new data received from the processor and old data retained on the non-volatile memory.

6. The method of claim 1, in which writing new data to NVM comprises writing the new data to NVM using bulk data processing.

7. The method of claim 1, in which receiving the done signal from the accelerator comprises sending a done signal from the accelerator to the processor when a data write is complete.

8. The method of claim 1, further comprising receiving metadata from a memory controller communicatively coupled to the processor defining the number and order of writes to the new data.

9. The method of claim 6, in which the metadata is received by the transaction accelerator from the memory controller via a dedicated bus communicatively coupling the memory controller to the NVM.

10. An apparatus for high performance persistent memory, comprising:
a processor;
a memory controller communicatively coupled to the processor; and
a non-volatile memory communicatively coupled to the memory controller and processor, the non-volatile memory comprising an ACID transaction accelerator;
in which the processor:
updates data on the non-volatile memory (NVM) by writing new data to the NVM; and
receives a done signal from the an ACID transaction accelerator when the data has been updated.

11. The apparatus of claim 10, in which the ACID accelerator, when instructed by the processor:
reads old data;
logs the old data to NVM; and
writes buffered new data to NVM.

12. The apparatus of claim 10, in which the memory controller is communicatively coupled to the NVM via a dedicated bus, and in which the memory controller sends to the NVM metadata defining the number and order of writes made to the new data.

13. The apparatus of claim 10, in which the ACID accelerator sends a done signal to the processor when the data has become persistent.

14. The apparatus of claim 10, in which the new data received comprises a number of partially committed transactions and in which, upon exceeding a threshold limit of the number of partially committed transactions in the buffer, the transaction accelerator instructs the memory controller to flush a number of dirty cache lines of a number of finished transactions.

15. A computer program product for performing ACID transactions in a high performance persistent memory device, the computer program product comprising:
a computer readable storage medium comprising computer usable program code embodied therewith, the computer usable program code comprising:
computer usable program code to, when executed by a processor, update data by writing new data to non-volatile memory (NVM); and
computer usable program code to, when executed by a processor, receive a done signal from a transaction accelerator communicatively coupled to the NVM.
